(19) United States
(12) Patent Application Publication
(10) Pub. No.: US 2009/0080849 A1
(43) Pub. Date: Mar. 26, 2009

(54) BLANK PLATE FOR MANAGING CABLES

(75) Inventors: Christopher Hankins, Santa Rosa, CA (US); Todd A. Newhouse, Rohnert Park, CA (US); Joseph F. Kidd, Santa Rosa, CA (US); Mark Patrick Richtman, Novato, CA (US)

Correspondence Address: FITZPATRICK CELLA HARPER & SCINTO, 30 ROCKEFELLER PLAZA, NEW YORK, NY, 10112, US

(73) Assignee: TELLABS PETALUMA, INC., Naperville, IL (US)

(21) Appl. No.: 11/858,451

(22) Filed: Sep. 20, 2007

(51) Int. Cl. G02B 6/00

(52) U.S. Cl. 385/135

(57) ABSTRACT

A blank or parking plate for managing cables, particularly fiber optic cables, having a planar base, removably securable to a chassis, and at least one resilient holder removably inserted through an aperture in the base, for securing and enclosing an end portion of a cable. The blank plate with at least one holder is arranged so as not to extend substantially within the chassis. The holder may secure a male cable connector end in substantially the same position and orientation that it will occupy when inserted into a female connector of an active circuit board, which replaces the blank plate. A distensible opening to an enclosure inside the holder may protect the cable end from dust or contact damage with foreign objects by defining an inner space behind an inlet for the cable, but no further opening serving as an outlet for the cable.

### BACKGROUND

1. Field

This invention generally relates to a blank plate for managing cables and, more particularly, for storing and protecting cables prepared in advance for future use in electronic and/or optical telecommunications equipment or the like.

2. Description of the Related Art

An electronics or optical equipment frame used by telcos and the like typically is subject to expansion during its useful life, i.e., additional circuit boards or cards will be installed. When a card is added to the frame, additional cables are required to connect the card to the appropriate external components. The additional cables need to be cut to the proper length, verified that they have been cut to the proper length, and routed and connected to the added card. It is often advantageous to cut, verify and route the additional cable in advance of the time at which an expansion card is added. It is important to store unused cables in a protective manner prior to installation of a new expansion card. For example, the present invention has particular utility with a Tellabs 8865 ServiceAware GPON Optical Line Terminal (OLT) system, which employs a chassis that supports up to 98 GPON ports for switching and routing, with 8 ports on each separate circuit board, or on each blank.

In this regard, fiber optic cables are more delicate than copper cables, and require increased vigilance and a secure and protective storage. Accordingly, it would be advantageous to provide a way to store and protect fiber optic cables that have cut, verified and routed in advance of the installation of expansion cards in a frame.

Optical fiber connectors permit connections either between two fibers, by physically aligning the cores of the fibers with one another, or to connect a optical fiber to a light source (e.g., a laser) or a receiver. Many commercially available connectors include four basic components: a ferrule; a connector body; a cable; and a coupling device. A ferrule is a long, thin cylinder in which the fiber is mounted. The end of the fiber typically is located at the end of a ferrule held in a connector body, typically of plastic with pieces to hold the fiber in place. The ferrule extends past the connector body to slip into a coupling device. A cable is attached to the connector body. Typically a strain-relief boot is added over the junction between the cable and the connector body, providing extra strength to cable that location.

Examples of commercially available optical fiber connectors include SMA 906 connectors (Amphenol Corp.), ST connectors (introduced by AT&T), FC connectors (introduced by NTT), D4 connectors (designed by NEC), HMS-10 (by Diamond, Inc.), and SC connectors (from NTT). A Singlemode application, type SC connector is illustrated in the drawings in an example embodiment of the invention. Such a configuration commonly is used in long-haul network connections by telcos when fiber optical cabling is used for connections between switching offices. Examples of a single cable connector system are illustrated within Akins et al. (U.S. Pat. No. 5,828,804) and examples of duplex cable connector system are illustrated within Connelly et al. (U.S. Pat. No. 6,511,230).

An example of a prior, elongated card that simply replaces an active circuit with clamps and a stop for engaging an unused single fiber optic cable end inside of a chassis is illustrated at FIG. 2 of Gehrke et al. (U.S. Pat. No. 6,487,358). Further examples of prior optical fiber cable management structures are illustrated within Musetti (U.S. Pat. No. 6,459,841); Griffiths et al. (U.S. Pat. No. 6,810,194) and Tirrell et al. (U.S. Pat. No. 6,791,841).

### SUMMARY OF THE INVENTION

The present invention addresses the challenges discussed above.

According to an example aspect of the present invention, there is provided a blank plate for managing cables, including a planar base that is removably securable to a chassis, with at least one resilient holder being removably secured simply within the planar base, for securing a cable end. The blank plate does not extend at all within the chassis, and the resilient holders do not extend substantially within the chassis, leaving a large open space behind each holder.

According to a another example aspect of the present invention, there is provided a blank plate for managing cables, including a base, that is removably securable to a chassis, with at least one resilient holder, removably secured to the base, for securing a cable end at a position that is not substantially within the chassis but instead substantially at the same position of the cable when secured to a circuit board, instead of the blank plate.

According to still a further example aspect of the present invention, there is provided a device for managing unused cables, including a base for attaching to a chassis surface that is a blank plate with at least one holder of molded rubber being removably held within an aperture of that blank plate by a grommet configuration proximate the middle of that holder. The holder has a front opening to an enclosed space that is adapted to accept a cable end. The back of the holder is closed and does not extend substantially within the chassis. The rubber holder can be easily pulled into the base plate aperture by an optional handle, formed on the back of the holder.

Further example aspects of the present invention include the following features. The holder may be removably securable directly to the base, without an intermediary member between the holder and the base. The holder may secure a portion of the cable in a straight position within the holder, so the end of the cable is constrained an angle greater than 0° and less than or equal to 90° with respect to the base. The base may be removably secured to a carrier, with that carrier then being removably secured to the chassis. Such a carrier may be capable of having at least two bases removably secured thereto. The cable end may be removably engaged inside the holder by means of resilient contact against a cable end connector. The cable may be an optical fiber. The blank plate may include no electronic or optical parts. While a single cable and connector application of the SingleMode type, with common SC type connectors, is illustrated in the following embodiments, the invention is equally applicable to a duplex cable and connector system.

A better understanding of these and other aspects, features, and advantages of the invention may be had by reference to the drawings and to the accompanying description, in which example embodiments of the invention are illustrated and described.

### BRIEF DESCRIPTION OF THE DRAWINGS

FIG. 1 is a front and side perspective view of a blank plate according to an example embodiment of the present invention.

FIG. 2 is a rear and side perspective view showing a portion of the blank plate of FIG. 1.

FIG. 3 is a fragmentary cross-sectional view of the blank plate of FIGS. 1 and 2.

FIG. 4 is a front and side perspective view of a carrier holding two of the blank plates shown in FIGS. 1-3.

FIG. 5 is a fragmentary front perspective view of a chassis with three carriers holding three blank plates with cables secured to resilient holders; are blank plate without cables secured therein, and circuit boards.

Throughout the figures, like or corresponding reference numerals are used to identify like or corresponding parts.

### DETAILED DESCRIPTION OF THE EXAMPLE EMBODIMENTS

An example embodiment of the present invention comprises a blank plate 100, which stores and protects cables 110 that are cut, verified and routed in advance of the installation of expansion cards in a frame. Blank plate 100 may be thought of functionally as a dummy or “parking” card which is substantially flat, with structure that differs significantly from that of an elongated, active or functional card. The structure and function of blank plate 100 according to example embodiments of the invention are described below.

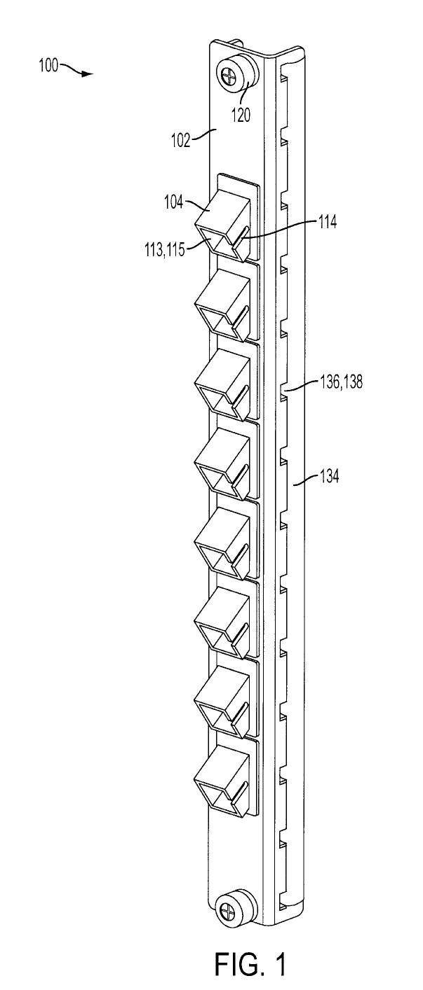

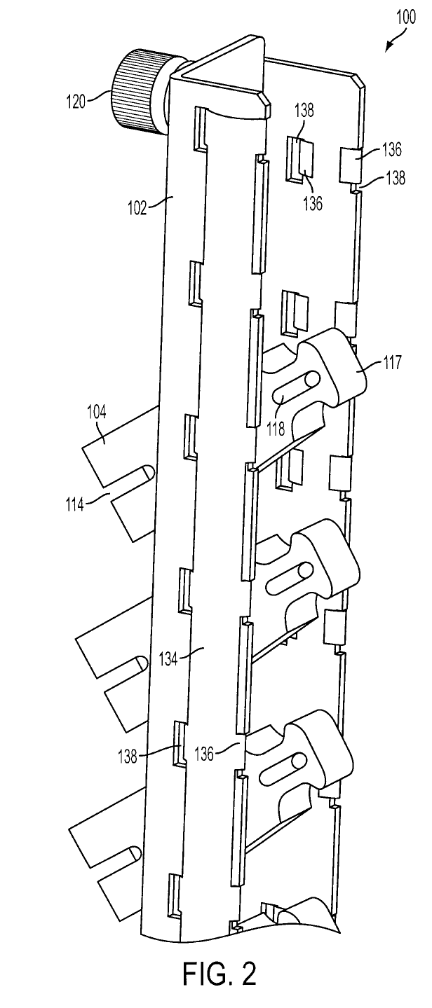

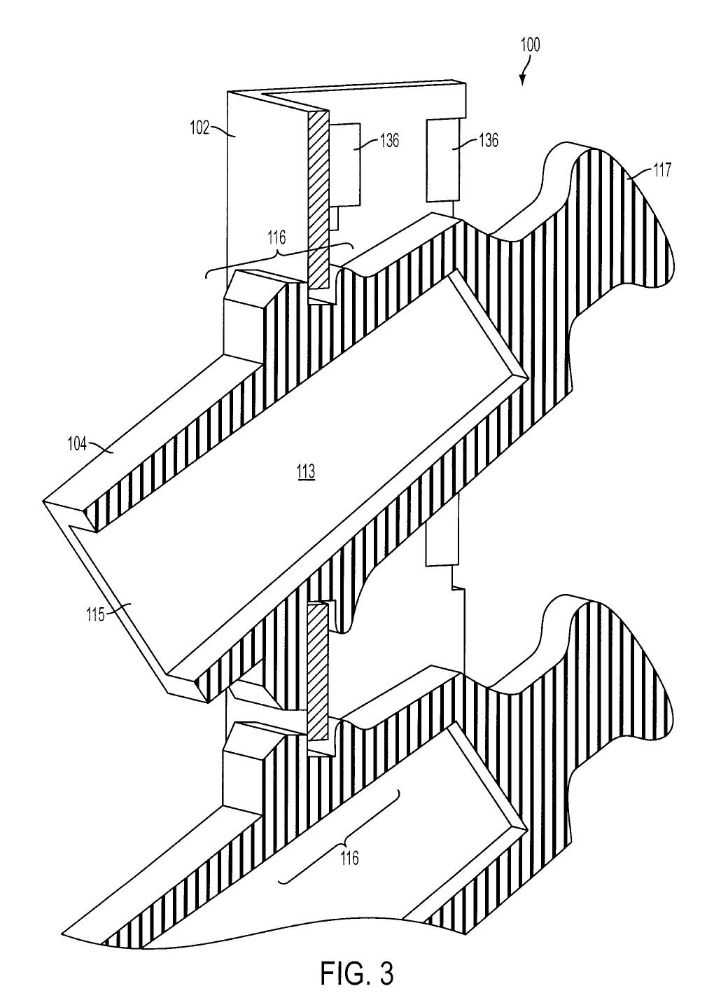

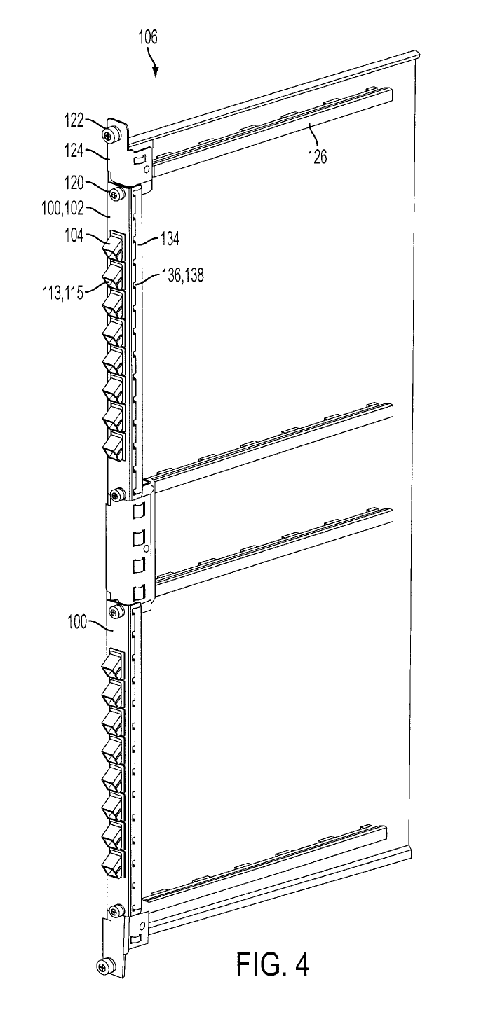

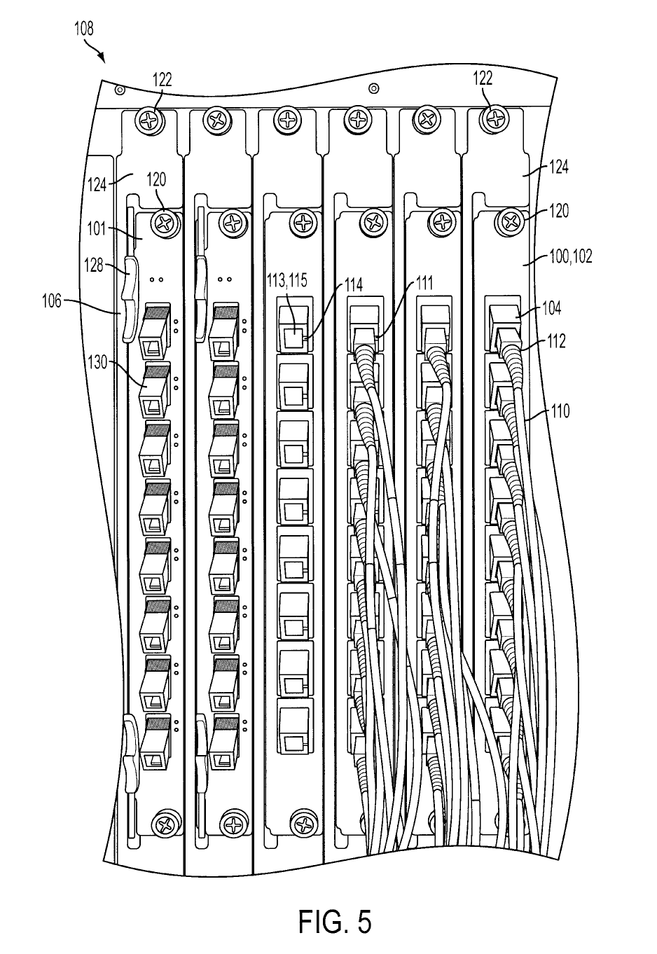

FIG. 1 is a front and side perspective view of a blank plate 100 according to an example embodiment of the present invention. FIG. 2 is a rear and side perspective view showing a portion of blank plate 100 of FIG. 1. FIG. 3 is a fragmentary view of blank plate 100 of FIGS. 1 and 2 with two resilient holders shown in cross-section. FIG. 4 is a front and side perspective view of a carrier 106 holding two blank plates 100. FIG. 5 is a fragmentary front perspective view of a chassis 108 holding carriers 106, active with a pair of active circuit boards 101 next to four blank plates 100. Cables 110 are secured to holders on three of the four blank plates 100.

Blank plate 100 comprises a base surface 102 into which resilient holders 104 are inserted. Two such blank plates 100 commonly would be held in a carrier 106, as shown in FIG. 4. Several carriers 106 may engage a chassis 108, as shown in FIG. 5. Due to the fragmentary nature of FIG. 5, only the upper portions of six carriers 106 are shown. Each of the two carriers 106 shown on the left side in FIG. 5 holds in its upper portion a functioning or active card or circuit board 101. Each of the three carriers 106 shown on the right side in FIG. 5 holds in its upper portion a blank plate 100 with eight holders 104 mounted therein and a cable 110 secured to each holder 104. The sixth carrier 106, which is located between the two carriers 106 shown on the left and the three carriers 106 shown on the right in FIG. 5, holds in its upper portion a blank plate 100 with eight holders 104 mounted therein, but with no cables 110 secured to holders 104, for clarity of illustration.

The term “chassis” is to be understood in the broadest possible sense. As an example, the term may refer to a cabinet, frame or the like for housing equipment such as electronics equipment, telecommunications equipment, etc. Such a chassis commonly, though not necessarily, has multiple shelves and slots for accommodating circuit boards or cards having, e.g., optical or electrical components mounted thereon. Such components may typically, but need not, be connected to a communications network via, e.g., fiber optic or other cables. The example embodiments of the invention discussed herein have particular, although not exclusive, application to optical telecommunications equipment.

The term “cable” is also to be understood in the broadest possible sense, and contemplates single and duplex cable configurations. The term subsumes any conduit, e.g., electrical, optical or other such media used to transmit and/or receive data or information. The example embodiments of the invention discussed herein have particular, although not exclusive, application to fiber optic cables, which may also be referred to herein as optical fibers. Suitable modifications to the example embodiments discussed below for the purpose of adapting those example embodiments for use with electrical cables, to the extent that such modifications would be necessary or desirable, would be known to those of skill in the art in view of the descriptions herein.

The term “carrier” is also to be understood in the broadest possible sense. As an example, the term refers to a member that accommodates one or more circuit boards or cards, or blank plates, dummy cards or the like, and that may be accommodated in a chassis.

Each cable 110 may be provided with a connector 112 at one or both ends of cable 110. For example, a fiber optic cable end may have a secured connector 112 that frictionally engages into the rectangle opening 113 of a rubber holder 104

The illustrated SC type connector 112 male portion is plastic and includes a key 111 (FIG. 5) that is intended to snap or frictionally engage an SC type female plastic connector body 130, of an active circuit board 101. As shown in FIG. 5, the key 111 on an SC type connector male portion 112 also readily may slide into a slot 114 formed in one side of an opening that simulates an SC type female style opening, which is formed in a rubber or plastic version of holder 104. Any suitable type of connector known in the art also may be employed. It is not necessary for holder 104 to have a slot 114. The holder 104 holds cable 110 in place in any number of ways, as will be appreciated by one of skill in the art in view of this description. Holder 104 may be resilient, to hold connector 112 by means of an interference or frictional fit with an opening or an inner surface of an enclosure of holder 104. Cable 110, whether single or duplex [not shown], may be removably secured to holder 104 by any suitable mechanism known to those of skill in the art in view of this description.

It is further noted that it is possible to fasten a cable 110 to a holder at a position other than the absolute end of that cable. It is further noted that use of a connector 112 on the end of a cable is not required.

The term “secure” as used herein means to hold in place in the broadest sense, not necessarily involving a physical connection of the two items secured to one another and not necessarily requiring that the secured items cannot move. For example, a wire running through a channel may be deemed secured in the channel insofar as the range of motion of the wire, or the range of positions the wire can occupy, is limited. In contrast, the terms “attach,” “connect,” “join,” and “fasten” as used herein are all taken as requiring a physical connection between two items.

In this regard, it is possible for cable 110 to be merely secured against, but not firmly attached to holder 104. Ways of securing cable 110 to holder 104 will be known to those of skill in the art in view of this description.

Holder 104 is illustrated to be of a molded rubber or like resilient material, and a simulation of an SC type female connector, with a rectangular inner spacel 13 behind an SC type opening or inlet 115 at a front end thereof adapted to distend if needed to engage against both an SC type male portion connector 112 and possibly also an exterior sheath of a Singlemode fiber optic cable 110. Opening 115 thus serves as an inlet for either the sheath of a cable 110 or just a connector 112. Holder 104 may be formed so that, aside from the inlet 115, the inner space 113 constitutes a closed space. Forming holder 104 as closed space may help protect cable 110 from physical damage, dust, and the like.

It is not necessary to form holder 104 as such an enclosing structure. For example, the rear end of holder 104 could be open. Holder 104 alternatively could have an inner space 113 that is ring-like or semi-cylindrical, to engage resiliently against an exterior sheath surface of a cable 110.

The term “enclosure” as used herein is not to be taken as necessarily so fully enclosing as are the holders 104 illustrated in the figures. Rather, the term is intended to subsume a structure that to some degree encloses the enclosed item from its surroundings.

Holder 104 may be of rubber and include an outer grommet-like portion 116, as shown in FIG. 3, proximate to the midpoint of the holder for the purpose of easy mounting by pulling into a complementary aperture in a planar blank plate 100. Grommet-like portion 116 provides a secure and stable fit, while permitting easy insertion and easy removal. As shown in FIGS. 2 and 3, holder 104 also may have a handle 117 that further comprise a hole or slot 118 (FIG. 2) formed into only one-half of its thickness. The provision of slot 118 in handle 117 facilitates compressing holder 104, e.g., by squeezing handle 117, for the purpose of pulling holder 104 into the aperture or pushing the holder 104 out from the plate 102. It is not necessary for holder 104 to be formed with a grommet-like portion or to have a handle or slot therein. As will be appreciated by one of ordinary skill in the art in view of this description, holders 104 may be held in place in base 102 in any number of ways. For example, holders 104 may be fastened to base 102 by any suitable fastening mechanism known to those of skill in the art in view of this description. Further, it is possible for holders 104 to be merely secured, not attached, to base 102. Ways of securing holder 104 to base 102 will be known to those of skill in the art in view of this description.

Base 102 of blank plate 100 may be a planar member fastened to a chassis 108 through a carrier 106 by means of a screw or screw assembly 120. Screw assembly 120 may, but need not, be a captive fastener, such that the screw remains fastened to the screw assembly 120 or base 102 even when fully loosened and when blank plate 100 is removed from carrier 106. One of ordinary skill in the art will appreciate in view of this description that any other type of suitable fastener may be used to fix blank plate 100 to chassis 108. Active card 101 typically will be fastened to carrier 106 by means of an identical or similar screw or screw assembly 120, or by such other suitable fastener as may be used to join blank plate 100 to carrier 106.

As shown in FIGS. 4 and 5, carrier 106 may be fastened to chassis 108 by means of screw assembly 122, which is located on mounting bracket 124. Screw assembly 122 may be similar to screw assembly 120 described above. Neither screw assembly 122 nor mounting bracket 124 as described herein are necessary. One of ordinary skill in the art will appreciate in view of this description that any type of suitable fastener may be used to join a carrier 106 to chassis 108.

Carrier 106 may be thought of as a convenient intermediary between a blank plate 100 and a chassis 108. It is not required to employ carrier 106 or any other intermediary or the like. It is possible to suitably modify chassis 108 so that blank plate 100 can be fastened directly to, or mounted or fitted directly in, chassis 108. Ways to accomplish this will be understood by one of ordinary skill in the art in view of this description.

A conventional carrier 106 typically will have slots (not shown) for holding either blank plates 100 or cards 101. As shown in FIG. 4, carrier 106 may include card rails 126 for mounting cards 101 in the slots of carrier 106. One card rail 126 may be provided to help secure the top of card 101 and one card rail 126 may be provided to help secure the bottom of card 101. The example embodiment illustrated in FIG. 4 carrier 106 accommodates two cards 101, one in an upper slot and one in a lower slot and carrier 106 is provided with four card rails 126. The number of card rails 126 per card 101 may vary, as will be understood by one of ordinary skill in the art in view of this description. Card rails 126 are not necessary, and cards 101 may be mounted or fitted into carrier 106 in any of a variety of suitable ways, which will be understood by one of ordinary skill in the art in view of this description.

A chassis 108 typically will have slots for accommodating carriers 106, and may include rails (not shown) similar to card rails 126 for helping secure carriers 106. As shown in FIG. 5, a chassis 108 may conventionally include an ejector 128 for ejecting cards 101 therefrom. Such rails in chassis 108 and ejector 128 are not required, and one of ordinary skill in the art will appreciate in view of this description a variety of ways in which carriers 106 may be removably mounted in chassis 108. As noted above, one of ordinary skill in the art will also appreciate in view of this description a variety of ways in which chassis 108 may be configured so that blank plates 100 may be removably mounted therein directly without the use of intermediate members such as carriers 106.

As will be appreciated by one of ordinary skill in the art in view of this description, it will generally be advantageous and convenient for all of the connections, mountings, and the like described herein to be capable of being easily released, undone or the like, although this is not an absolute requirement.

A typical carrier 106 will hold two blank plates 100. In FIG. 4, two cards 101, one blank plate 100 and one card 101, one blank plate 100 only, one card 101 only, or no blank plates 100 and no cards 101 are illustrated. The contents (blank plates or active cards) of carriers 106 may be arranged and rearranged at will by a user, e.g., as needed in view of the requirements of the system in which the equipment described herein is being used.

It will be appreciated by one of ordinary skill in the art in view of this description that the design of the various components described above may be modified to vary the number of holders that may be accommodated on a single blank plate, the number of blank plates and/or cards that may be accommodated in a single carrier, and the number of carriers (or, in other example embodiments, blank plates and/or cards) that may be accommodated in a single chassis. Similarly, the spacing between, or location of, holders on a blank plate may be modified, as will be appreciated by one of ordinary skill in the art in view of this description. As an example, a blank plate could be made having a double width, thus accommodating two rows of holders, side by side.

Operation of an example blank plate 100 will be further described below. Blank plates 100 may be provided in sufficient number to fill some or all of the unpopulated slots of a chassis 108, while not intruding any substantial distance into the chassis space. Unused cables 110 may be provided in sufficient number to connect to some or all holders 104 of blank plates 100, so as to accommodate quick and efficient future installation of expansion cards. Hence, unused fiber optic cables 110 with functional male connectors may be temporarily and safely parked inside holders 104 on a blank until an active card is required to replace that blank.

Whenever it is desired to install an expansion card 101, i.e., a dummy card or blank plate 100 can be replaced with a new, active circuit board 101, which does substantially extend inside the chassis, using the following steps. Ends of unused cables 110 are disconnected from holders 104 of a blank plate 100 to be replaced, which then is disconnected from carrier 106 by means of screw assembly 120 and slid out of its slot in carrier 106. An expansion card 101 is slid into the empty slot in carrier 106 along card rails 126 and connected to carrier 106 by means of its screw assembly 120. Cables 110 which had been disconnected from inactive holders 104 then are connected to active holders 130 (FIG. 5) of card 101. This completes the operation of installing expansion card 101. The procedures for installing expansion card 101, i.e., replacing blank plate 100 with expansion card 101, may be varied, as will be understood by one of ordinary skill in the art in view of this description. For example, the order of procedures may be varied, e.g., blank plate 100 could be removed from carrier 106 prior to disconnecting cables 110 from blank plate 100, etc. Of course, the procedures may also be appropriately varied for the above-described case in which blank plate 100 is fitted directly into chassis 108 without use of carrier 106, as will be understood by one of ordinary skill in the art in view of this description.

As seen from the above description of example embodiments of the invention, blank plate 100 serves to store and protect unused cables 110 that are cut, verified and routed in advance of the installation of an expansion card 101. In particular, blank plate 100 retains cables 110 in such a manner as to minimize handling of cables 110 and contact of delicate end portions of unused cables 110 with foreign objects, without requiring an elongated metal dummy circuit board and interior holding clamps and end stops, for example, which must be located substantially inside the chassis space. Further details in this regard, as well as additional advantages provided by example embodiments of the invention, are discussed below.

In the example embodiments illustrated in the figures, blank plate 100 is formed as a faceplate-like flat structure, which does not extend substantially within carrier 106 or chassis 108. In contrast, an active expansion card 101 extends substantially the length of card rails 126. A blank plate 100 requires only a relatively small amount of material for manufacture thereof, as compared to card 101, and does not require use of card rails 126 for mounting on carrier 106 (or, in other example embodiments, similar rails for mounting directly in chassis 108), thus reducing the load on the rails. In addition, as shown in the figures, blank plate 100 is relatively simple in configuration (shape, etc. of base 102, holders 104, etc.), which simplify design and manufacture thereof.

A blank plate 100 does not provide any elongated surface extending into the chassis, since no manner of active, functioning electronic or optical components are associated with the enclosure inside the rubber holder, 104. A holder 104 made of molded rubber is easily secured or attached to simple apertures formed in the planar base 102 directly, without need for any intermediate member, to achieve the connection. In that regard, a resilient grommet outer surface configuration molded on the holder, proximate its midsection, particularly allows inserting the holder in a simple fashion, and greatly simplifies manufacture. All of these aspects of blank plate 100, while not required, may reduce costs of manufacture and increase durability and reliability.

In the example embodiments illustrated in the figures, holders 104 are mounted at an angled orientation relative to the face or front surface of base 102 in which they are mounted. Holders 104 are also mounted in the same position and orientation in base 102 as holders 130 are mounted in card 101. These features of holders 104, while not required, may serve to protect cables 110 by ensuring a minimum bend radius of cables 110, so as not to overly strain cables 110.

In FIG. 5, the angle of orientation of holders 104 is in conformity with a downward direction in which cables 110 are arranged. Depending on the configuration of a larger system in which a chassis 108 is disposed, it may be desired to direct cables 110 in an upward direction. The blank plate 100 easily can be rotated so that holders 104 are open upwardly at an angle in conformity with the direction in which cables 110 are arranged. It is also possible, for example, to have a carrier 106. With one blank plate 100 having holders mounted at an upward angle and one blank plate 100 having holders mounted at a downward angle. The upper set of cables 110 could be routed away from chassis 108 at the top of chassis 108, to be routed onward to their destinations, while the lower set of cables 110 could be routed away from chassis 108 at the bottom of chassis 108, to be routed onward to their destinations.

For purposes of describing the angle at which the holders 104 are mounted in base 102, 0° will be taken as referring to the case in which holder 104 lies parallel to base 102 in an upward direction, 90° will be taken as referring to the case in which holder 104 lies normal to base 102, extending outward from the face or front surface of base 102 (i.e., outward from the plane of the paper in FIG. 5), and 180° will be taken as referring to the case in which holder 104 lies parallel to a substantially planar base 102 in a downward direction.

In the example embodiments described and illustrated herein, holders 104 have been described as being mounted at an angle between 0° and 90° (i.e., mounted at an upward angle) or at an angle between 90° and 180° (i.e., mounted at a downward angle), with respect to base 102. Such upward and downward angles are suitable for the purpose of ensuring a minimum bend radius and thus avoiding undue strain on cables 110, in some common configurations of a system including a chassis 108 from which cables 110 are routed to other components. The angle of a mounting holder 104 may be varied as appropriate in view of a system configuration, for the purpose of avoiding excessive strain on cables 110 as will be understood by those of ordinary skill in the art. In addition to avoiding excessive strain on cables 110, another purpose achieved by mounting resilient holders at an angle other than 90°, is to reduce the amount of space required for a system. By mounting holders 104 at an angle other than 90°, the amount of space required in front of chassis 108 is reduced as compared with holders 104 mounted at an angle of 90°. In view of the above discussion, the term “orientation” may be used to refer to the angle at which holders 104 are mounted or, similarly, at which cables 110 are secured in holders 104.

The base 102 configuration is illustrated with holders 104 to be mounted at only a single given angle. Alternatively, base 102 could be formed in for permitting holders 104 to be mounted at different angles. For example, base 102 could be formed in a configuration permitting holders 104 to be rotatable between one or more upward angled positions and one or more downward angled positions, at each of which holders 104 could be releasably held in place. Other example configurations of base 102 in this regard are possible.

The example embodiments illustrated in the figures, holders 104 hold cables 110 having a male connector 112 at the end of each cable. In FIGS. 2 and 3, each of the holders 104 is open only at a front end, with an opening 115, but otherwise are full enclosures. Ends of cables 110 enter into respective inner spaces 113 through inlets 115, and do not exit from holders 104. The portion of cable 110 within inner space 113 is protected from ambient and any foreign objects outside holder 104. The slot 118 (FIG. 2) is a simulation of a slot found on a female SC type holder and does not go all the way through holder 104, and also does not communicate with the inner space of enclosure 113, which protects the end of cable 110. These aspects of these example embodiments, although not required, help protect cable ends or connectors from dust and the like, as well as from contact with other objects which could potentially damage a cable.

Either a blank plate 100 or an active card 101 optionally may have an electromagnetic shield 134 provided along the length of the side of base 102, as shown in FIGS. 1-4. Such an electromagnetic shield 134 may be releasably connected to base 102 by means of a plurality of periodically spaced clips 136 formed in electromagnetic shield 134, which are inserted through corresponding openings 138 in the side of base 102 and then bent back against the other, or interior side of openings 138. Chassis 108 and carrier 106 may be designed such that the electromagnetic shield 134 of a given blank plate 100 or card 101 installed therein may be in contact with the electromagnetic shield 134 of an adjacent blank plate 100 or card 101 installed therein. Electromagnetic shield 134 prevents or reduces electromagnetic interference by preventing or reducing the transmission of electromagnetic radiation past a blank plate 100, which might then interfere with an adjacent active card 101. Electromagnetic shield 134 may be varied, e.g., as to its structure, mode of connection with base 102, and other aspects, as will be appreciated by one of ordinary skill in the art in view of this description.

As for the materials of composition of blank plate 100, base 102 may be made of metal, plastic, fiberglass, or other materials. One example of metal for this purpose is steel. For the purpose of electromagnetic shielding, metal may be more advantageous than plastic.

Holders 104 may be made of natural rubber or a blend thereof, a synthetic vinyl or nylon, or other materials. Examples of such resilient materials for this purpose include EPDM (ethylene propylene diene monomer), silicone or any soft thermoplastic material.

Electromagnetic shield 134 may be made of, e.g., copper, or other suitable materials. The range of such materials is understood to be known to one of ordinary skill in the art.

The details of the present invention as described above and illustrated in the accompanying figures are to be taken as examples and not as limiting. It is understood that to the extent any details pertinent to the invention are omitted herein, they are known to those of skill in the art.

One of ordinary skill in the art will realize that modifications and variations, including but not limited to those discussed above, are possible within the spirit and scope of the present invention. The invention is intended to be limited in scope only by the accompanying claims, which should be accorded the broadest interpretation so as to encompass all such modifications, equivalent structures and functions.

1. A blank plate for managing fiber optic cables, comprising:
a base, removably securable to a chassis; and
at least one holder, removably securable to the base, defining an enclosure for removably securing and protecting an end portion of a fiber optic cable against contact with foreign objects,
wherein the blank plate is arranged substantially externally from the chassis.

2. A blank plate as claimed in claim 1, wherein the at least one holder comprises a resilient material and is removably securable within a complementary aperture in the base, without an intermediary member between the holder and the base, the base being a planar member.

3. A blank plate as claimed in claim 1, wherein the at least one holder secures the end portion of the fiber optic cable in a straight position when inserted within the enclosure, and orients the end portion of that fiber optic cable at an angle greater than 0° and less than or equal to 90° with respect to the base.

4. A blank plate as claimed in claim 2, wherein the at least one holder defines the enclosure having an opening serving as an inlet for the end portion of the fiber optic cable but no further opening serving as an outlet for that fiber optic cable.

5. A blank plate as claimed in claim 1, wherein the base is removably securable to a carrier, the carrier is removably securable to the chassis, and the carrier is capable of having removably secured thereto at least two bases.

6. A blank plate as claimed in claim 1, wherein the at least one holder is configured such that the end portion of the fiber optic cable is removably attachable thereto, the end portion is further comprised of a connector, and the fiber optic cable is removably attachable to the at least one holder by means of a frictional engagement between an outer surface of the connector and an inner surface of the enclosure.

7. A blank plate as claimed in claim 6, wherein the holder comprises a resilient material having a distensible female opening serving as an inlet for a male connector on the end portion of the fiber optic cable but no further opening serving as an outlet for that fiber optic cable.

8. A blank plate as claimed in claim 1, wherein the blank plate includes no electronic or optical parts.

9. A blank plate for managing end portions of fiber optic cables, comprising:
a base, removably securable to a chassis; and
at least one holder, removably securable to the base, for removably securing an end portion of a fiber optic cable, at a position that is not substantially within the chassis and at an orientation that is substantially the same orientation as that in a case in which the end portion of the fiber optic cable would be secured to an active circuit board.

10. A blank plate as claimed in claim 9, wherein the base does not extend substantially within the chassis.

11. A blank plate as claimed in claim 9, wherein the at least one holder comprises a resilient material and is removably securable within a complementary aperture in the base, without an intermediary member between the holder and the base, the base being a planar member.

12. A blank plate as claimed in claim 9, wherein the holder is configured to secure the end portion of the fiber optic cable in a straight position within the holder, and orients the end portion of that fiber optic cable at an angle greater than 0° and less than or equal to 90° with respect to the base.

13. A blank plate as claimed in claim 9, wherein the holder comprises a resilient material and defines an enclosure having an opening serving as an inlet for the end portion of the fiber optic cable but no further opening serving as an outlet for that fiber optic cable.

14. A blank plate as claimed in claim 13, wherein the at least one holder enclosure further comprises an inner space behind a distensible opening that accepts the end portion of the fiber optic cable that further comprises a male connector.

15. A blank plate as claimed in claim 13, wherein the end portion of the fiber optic cable further comprises a connector and is removably attachable to the at least one holder by means of a frictional engagement between an outer surface of the connector and an inner surface of the enclosure.

16. A blank plate as claimed in claim 9, wherein the fiber optic cable is of the single cable type and the end portion of the fiber optic cable comprises an SC type male connector, and wherein the at least one holder further comprises an opening into the enclosure that simulates an SC type female connector and accepts the male connector.

17. A blank plate as claimed in claim 9, wherein the blank plate includes no electronic or optical parts.

18. A blank plate for managing end portions of cables, comprising:
a base, removably securable to a chassis; and
at least one holder for removably securing and protecting an end portion of a cable against contact with foreign objects, the holder being removably securable to the base and defining an enclosure within the chassis,
wherein the holder is of a resilient material and the enclosure further comprises an inner space behind a distensible opening serving as an inlet for the end portion of the cable but no further opening serving as an outlet for the end portion of the cable.

19. A blank plate as claimed in claim 18, wherein the base does not extend substantially within the chassis.

20. A blank plate as claimed in claim 18, wherein the at least one holder comprises a resilient material and is removably securable within a complementary aperture in the base, without an intermediary member between the holder and the base, the base being a planar member.

21. A blank plate as claimed in claim 18, wherein the at least one holder is configured to secure the end portion of the cable in a straight position within the holder, and orients the end portion of the cable at an angle greater than 0° and less than or equal to 90° with respect to the base.

22. A blank plate as claimed in claim 18, wherein the cable comprises a fiber optic communications cable and the end portion of the cable further comprises a connector.

23. A blank plate as claimed in claim 22, wherein the fiber optic communications cable is of the single cable type and the end portion of the cable further comprises an SC type male connector, wherein the holder further comprises a distensible female opening that simulates an SC type female connector and accepts passage of the male connector.

24. A blank plate as claimed in claim 18, wherein the blank plate includes no electronic or optical parts.
